(19) United States
(12) Patent Application Publication
(10) Pub. No.: US 2003/0230888 A1
(43) Pub. Date: Dec. 18, 2003

(54) Memorabilia album

(76) Inventor: Karl Wolfhard Grummich, Cincinnati, OH (US)

Correspondence Address: Donald E. Hasse, Hasse Guttag & Nesbitt LLC, Suite 316, 7577 Central Park Blvd., Mason, OH, 45040, US

(21) Appl. No.: 10/264,403

(22) Filed: Oct. 4, 2002

Related U.S. Application Data
(60) Provisional application No. 60/389,410, filed on Jun. 17, 2002.

(51) Int. Cl. B42D 3/00

(52) U.S. Cl. 281/29

(57) ABSTRACT

A memorabilia album useful for storing and displaying memorabilia items such as photographs, autographs, sports and entertainment cards, tickets, stamps, coins and other collectible items. The album has a flat rectangular case support structure, an internal clam shell box structure, and a means for securing the memorabilia items to the case support structure inside the clam shell box structure. The album has sufficient lateral stability to stand upright when placed on a piece of furniture such as a desk or bookshelf where it is readily accessible.

### BACKGROUND OF THE INVENTION

The present invention relates to a memorabilia album that is useful for both storing and displaying memorabilia items such as photographs, autographs, sports and entertainment cards, tickets, stamps, coins and other collectible items.

Conventional photo and memorabilia albums are often constructed in a manner similar to a book. The album typically comprises a plurality of pages upon which photographs or other items are mounted. The pages are bound together or otherwise secured at a common binding edge between the front and back covers, which are joined together by a spine. The binding edges of the pages are secured at the spine.

If one attempts to stand a conventional album upright resting on the bottom edges of the front and back covers, the album is likely to fall over since the front and back covers are normally too close together to provide sufficient lateral stability for the album to stand upright. On the other hand, if one attempts to provide the necessary lateral stability by spreading the outside edges of the front and back covers apart from each other, the album may still be unstable since the outside edges of the pages are then unsupported and tend to buckle. The weight of the pages pulling against the spine of the album may cause the album to collapse by falling in a forward direction.

Various types of reclosable containers are used for packaging consumer articles. One common type of package is known as the “clam shell” box. “Clam shells” generally include a rear base and a front cover that are hinged together, and mating skirts around the cover and base which join together when the front cover is closed over the rear base. Expensive clam shell boxes have been used to store loose papers, photographs and valuable items. Such boxes tend to be put away in desk drawers or closets, and the contents are often not organized or readily accessible.

While photo albums and clam shell boxes have been used to store various memorabilia items, there is a continuing need for an attractive album for storing and organizing such items, which album has sufficient lateral stability to stand upright when placed on a piece of furniture such as a desk or bookshelf where it is readily accessible.

### SUMMARY OF THE INVENTION

The present invention provides a memorabilia album comprising:

(a) a flat rectangular case support structure having opposing, mutually parallel, laterally extending edges, said case support structure being folded longitudinally to form a plurality of stiff panels joined to each other in articulated fashion by linear hinge connections that extend between said opposing laterally extending edges, wherein said plurality of panels comprise a pair of cover panels disposed on opposing sides of a central spine,

(b) an internal clam shell box structure having mating top, side and bottom flanges affixed perpendicular to said case support structure, said side flanges being located near the distal longitudinal edges of the case support structure and remote from the central spine, and

(c) a means for securing memorabilia items to said case support structure inside said clam shell box structure.

### BRIEF DESCRIPTION OF THE DRAWINGS

FIG. 1 is a perspective view of a memorabilia album according to the invention standing upright and fully closed.

FIG. 2 is a perspective view of the album of FIG. 1 shown in a fully open condition.

### DETAILED DESCRIPTION OF THE INVENTION

The memorabilia album of the present invention comprises a case support structure having front and back cover panels and a central spine, an internal clam shell box structure, and a means for securing memorabilia items to the case support structure on the inside of the clam shell box. The album performs the function of a conventional photo album, namely the storage and organization of memorabilia such as photographs, autographs, sports and entertainment cards, tickets, stamps, coins and other collectible items, and has the appearance of an attractive, freestanding book that has sufficient lateral stability to stand upright. The memorabilia album may thus be placed on a piece of furniture such as a desk, shelf, buffet, bookshelf or cabinet where it is readily accessible to the viewer.

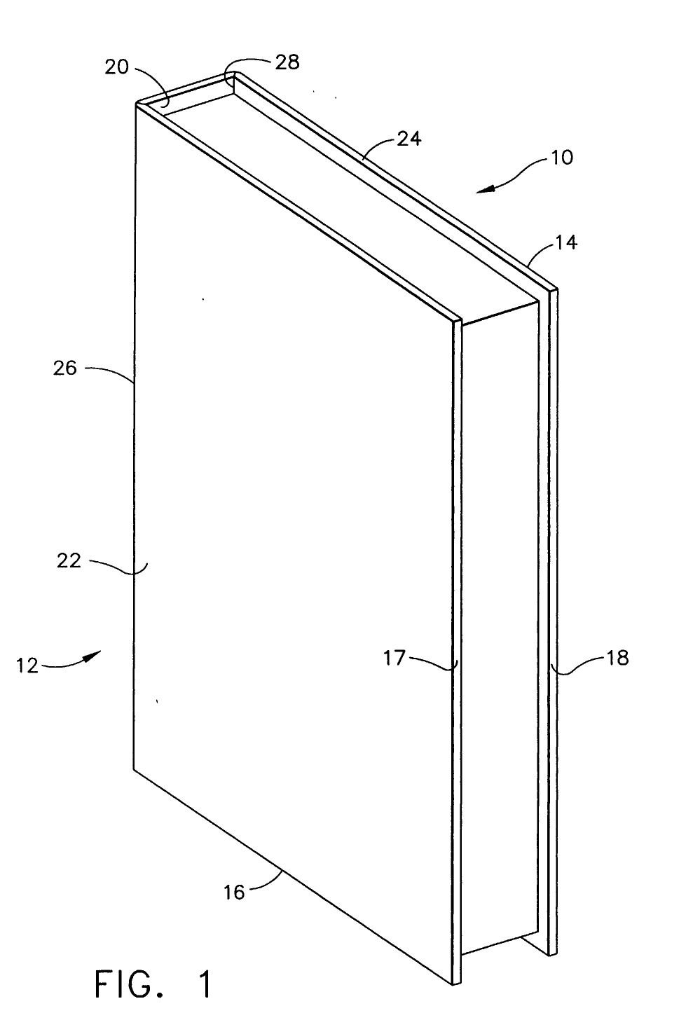

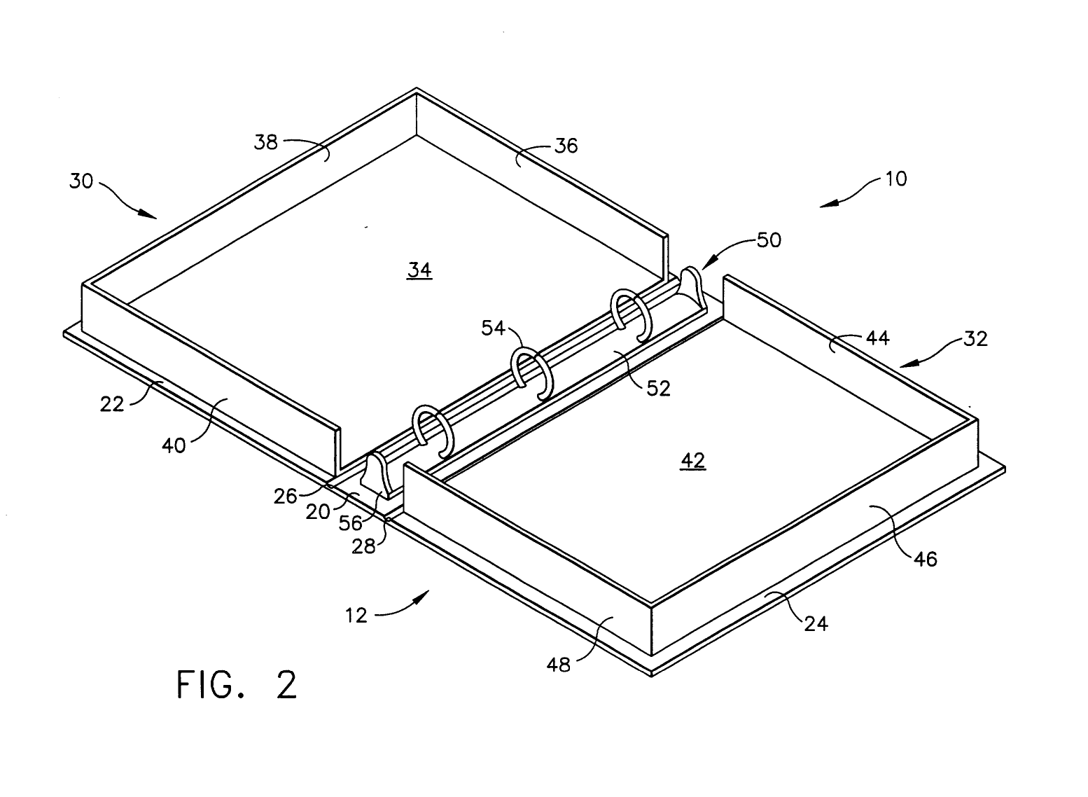

FIGS. 1 and 2 illustrate a memorabilia album 10 constructed according to the present invention. Album 10 is comprised of a case support structure 12 having an elongated, rectangular shape, as best shown in FIG. 2 when case 12 is in a fully open condition. As shown in FIG. 1, case 12 has mutually parallel, laterally extending top and bottom edges 14 and 16 respectively, longitudinally extending front and back edges 17 and 18 respectively (which typically also are, but need not be, mutually parallel, and also need not be linear, e.g., they may be curved), a longitudinally extending central spine 20, and a pair of generally flat, stiff, rectangular-shaped cover panels 22 and 24. Panels 22 and 24 are delineated from spine 20 by longitudinally extending hinged connections 26 and 28.

Case 12 may be constructed utilizing thin sheets of paper, plastic, fabric, leather, wood, or metal, or combinations thereof, to form or encapsulate therewithin flat, rectangular sections, for example core sections, that provide a certain degree of rigidity to cover panels 22 and 24, and preferably to spine 20. Spine 20 may also be made of a more flexible material, or it may not contain the core section that provides rigidity. The core sections may be formed of any suitable material such as fiberboard or a stiff sheet of plastic to provide the desired rigidity. Case 12 is preferably constructed of thin sheets of paper, plastic, fabric or leather, or combinations thereof.

As shown in FIG. 2, case 12 is divided by spine 20 that extends laterally between cover panels 22 and 24. The longitudinal hinged connections 26 and 28 delineate spine 20 from adjoining cover panels 22 and 24. Cover panels 22 and 24 are thereby located one on each side of spine 20.

As also shown in FIG. 2, album 10 further comprises left clam shell structure 30 and right clam shell structure 32 which, when case 12 is fully closed, form a clam shell box such as known in the art. Left clam shell 30 has a base 34, top flange 36, side flange 38, and bottom flange 40. Right clam shell 32 has a corresponding base 42, top flange 44, side flange 46, and bottom flange 48. Left clam shell 30 and right clam shell 32, and their component base and flange structures, may be constructed utilizing thin sheets of paper, plastic, fabric, leather, wood or metal, or combinations thereof, to form or encapsulate therewithin flat, rectangular sections, for example core sections, that provide a certain degree of rigidity to clam shells 30 and 32, and to the clam shell box when case 12 is closed. The core sections may be formed of any suitable material such as fiberboard or a stiff sheet of plastic, and typically are formed of the same material as the core sections of cover panels 22 and 24 and spine 20. Left clam shell 30 and right clam shell 32 are preferably constructed using thin sheets of paper, plastic, fabric or leather, or combinations thereof.

Left clam shell 30 and right clam shell 32 may be assembled by die-cutting and scoring fiberboard sheets, which are then formed and covered with the desired paper, plastic, fabric or leather material. This may be done by hand or by using a machine automated process. Once assembled, left clam shell 30 and right clam shell 32 are affixed to case 12 using, for example, glue, rivets, grommets, staples, adhesive tape, or other suitable materials and methods.

When case 12 is in a fully closed position, left clam shell 30 and right clam shell 32 fit together to form a clam shell box so that album 10 has the appearance of a book. As shown in FIG. 2, right clam shell 32 forms the inner portion of the clam shell box structure. In one embodiment, the dimensions of left clam shell 30, including base 34, top flange 36, side flange 38, and bottom flange 40 are slightly larger (for example, about 0.5 to about 2 mm larger) than those of right clam shell 32, including base 42 and flanges 44, 46 and 48, so that left clam shell 30 fits snuggly over right clam shell 32 when case 12 is fully closed. This provides improved lateral stability so that album 10 remains securely closed and is able to stand upright on a shelf or flat surface, even when it contains a large number of pages or other items to be stored therein. Alternatively, the dimensions of left clam shell 30 are slightly less than those of right clam shell 32 so that left clam shell 30 fits snuggly within right clam shell 32 when case 12 is closed.

Typically, the width of flanges 36, 38, 40, 44, 46 and 48 (as measured perpendicular to base 34 and base 42), is slightly less (about 5 to 8 mm less) than the width of spine 20. In a preferred embodiment, the length and width of flanges 44, 46 and 48 are slightly less than the length and width of flanges 36, 38 and 40, which are slightly less than the width of spine 20, respectively.

Album 10 further comprises a means for securing memorabilia items stored within its clam shell box structure. This securing means may be, for example, a ring binder mechanism, such as used in a typical three-ring binder; a clasp, sliding mechanism, snap-lock mechanism, poles or posts, nuts and bolts, or foldable prongs that can be used for locking and unlocking pages containing the memorabilia items; binding mechanisms using adhesives; or any of the various other loose-leaf mechanisms known in the art. Various securing means are disclosed in U.S. Pat. Nos. 5,213,370; 6,142,696; 6,267,413; and 6,379,070; all incorporated herein by reference.

In one embodiment of the invention, the securing means is a ringed binder mechanism which is formed by a spine (usually metal) having a plurality of split rings which can be opened and closed manually or via action of a lever. The split rings may also be biased closed via a spring mechanism. Various embodiments of the rings and binder are known in the art and may be used in the present invention, including the following. While three split rings are typically used in a binder, more or less may be used (see U.S. Pat. No. 5,042,841). Different shaped rings, e.g. a “D” shaped ring, are known (see U.S. Pat. No. 6,045,286 and U.S. Pat. No. 5,332,327), and different designs for the rings are known (see U.S. Pat. No. D408,851). Rings that slide within each other are also known (see U.S. Pat. No. 4,765,768), as are wrap-around covers (see U.S. Pat. No. 4,139,216). A flexible spine may be used as disclosed in U.S. Pat. No. 5,607,246. Various means for attaching the binder mechanism are known (see U.S. Pat. Nos. 6,019,538; 5,964,544; and 5,882,135). Mounting the ring binder mechanism on the rear cover (e.g., onto base 42 of right clam shell 32 in FIG. 2) instead of on the spine is also known (see U.S. Pat. No. 5,651,628; U.S. Pat. No. 5,607,246; and U.S. Pat. No. 5,332,327). Mounting the ring binder mechanism about a hinge to serve as an opening-closing mechanism is also disclosed in U.S. Pat. No. 5,028,159. An expandable, double ring binder is disclosed in U.S. Pat. No. 4,990,017, where the rings are mounted on the same cover spine portion. The disclosures of all of the above patents are incorporated herein by reference.

In a preferred embodiment as shown in FIG. 2, the securing means is a three-ring binder mechanism 50 comprising a spine 52, which is typically metal, three rings 54, also typically metal, and opening and closing tabs 56, also typically metal. Spine 52 is affixed to central spine 20, preferably using rivets or grommets (not shown). Rings 54 are shown in the closed position, and can be opened by applying force to tabs 56 in an outward direction parallel to spine 52, as is known in the art.

In another embodiment, the securing means may be the flexible binding apparatus disclosed in U.S. Pat. No. 4,375,925, Hugo Grummich, issued Mar. 8, 1983, incorporated herein by reference.

Album 10 typically contains a plurality of photograph or other memorabilia mounting pages (not shown) of conventional construction. For example, each mounting page may be formed of two sheets of thin, plastic material disposed in face-to-face contact and having mutually congruent perimeters, portions of which are heat sealed together to define at least one pocket therebetween.

A mounting page may also be sealed along its top and bottom edges, and along a horizontal line of sealing midway between the top edge and bottom edge to form an upper and lower pocket to receive two different photographs or other items therewithin. Pages containing three or more pockets (e.g., three rows containing three pockets per row) may be formed in a similar manner. The pockets are accessible for the insertion and removal of photographs or other memorabilia through the unsealed portions of the parameters of the transparent plies of sheet material forming each mounting page.

The foregoing invention has been described in terms of various embodiments. However, it will be apparent to those skilled in the art that modifications and variations can be made in the disclosed structures without departing from the scope or spirit of the invention. The specification and examples are exemplary only, while the true scope of the invention is defined by the following claims.

What is claimed is:

1. A memorabilia album comprising:
(a) a flat rectangular case support structure having opposing, mutually parallel, laterally extending edges, said case support structure being folded longitudinally to form a plurality of stiff panels joined to each other in articulated fashion by linear hinge connections that extend between said opposing laterally extending edges, wherein said plurality of panels comprise a pair of cover panels disposed on opposing sides of a central spine,
(b) an internal clam shell box structure having mating top, side and bottom flanges affixed perpendicular to said case support structure, said side flanges being located near the distal longitudinal edges of the case support structure and remote from the central spine, and
(c) a means for securing memorabilia items to said case support structure inside said clam shell box structure.

2. The album of claim 1 wherein the means for securing memorabilia items is a ring binder mechanism.

3. The album of claim 2 wherein the binder mechanism is affixed to the central spine.

4. The album of claim 3 wherein the width of the mating top, side, and bottom flanges is slightly less than the width of the central spine.

5. The album of claim 4 wherein the binder mechanism is a three-ring binder mechanism.

6. The album of claim 1 wherein the means for securing memorabilia items is a flexible binding apparatus.

7. The album of claim 6 wherein the flexible binding apparatus is affixed to the central spine.

8. The album of claim 7 wherein the width of the mating top, side, and bottom flanges is slightly less than the width of the central spine.

9. The album of claim 1 wherein the pair of cover panels and the central spine are constructed using thin sheets of paper, plastic, fabric or leather, or combinations thereof, to encapsulate therewithin flat, rectangular core sections that provide rigidity to the cover panels and the spine.

10. The album of claim 9 wherein the mating top, side and bottom flanges of the clam shell box structure are constructed using thin sheets of paper, plastic, fabric or leather, or combinations thereof, to encapsulate therewithin flat, rectangular core sections that provide rigidity to the flanges.

11. The album of claim 10 wherein the core sections are formed of fiberboard.

12. The album of claim 11 wherein the means for securing memorabilia items is a ring binder mechanism.

13. The album of claim 12 wherein the binder mechanism is affixed to the central spine.

14. The album of claim 13 wherein the binder mechanism is a metal three-ring binder mechanism.

15. The album of claim 14 wherein the width of the mating top, side, and bottom flanges is slightly less than the width of the central spine.

16. The album of claim 11 wherein the means for securing memorabilia items is a flexible binding apparatus.

17. The album of claim 16 wherein the flexible binding apparatus is affixed to the central spine.

18. The album of claim 16 wherein the width of the mating top, side, and bottom flanges is slightly less than the width of the central spine.

19. A memorabilia album comprising:
(a) a flat rectangular case support structure having opposing, mutually parallel, laterally extending edges, said case support structure being folded longitudinally to form a plurality of stiff panels joined to each other in articulated fashion by linear hinge connections that extend between said opposing laterally extending edges, wherein said plurality of panels comprise a pair of cover panels disposed on opposing sides of a central spine,
(b) an internal clam shell box structure having mating top, side and bottom flanges affixed perpendicular to said case support structure, said side flanges being located near the distal longitudinal edges of the case support structure and remote from the central spine, and
(c) a ring binder mechanism, affixed to the central spine, for securing memorabilia items to said case support structure inside said clam shell box structure.

20. The album of claim 19 wherein the pair of cover panels and the central spine are constructed using thin sheets of paper, plastic, fabric or leather, or combinations thereof, to encapsulate therewithin flat, rectangular core sections that provide rigidity to the cover panels and the spine; and wherein the mating top, side and bottom flanges of the clam shell box structure are constructed using thin sheets of paper, plastic, fabric or leather, or combinations thereof, to encapsulate therewithin flat, rectangular core sections that provide rigidity to the flanges.
